(19) United States
(12) Patent Application Publication
(10) Pub. No.: US 2025/0266186 A1
(43) Pub. Date: Aug. 21, 2025

(54) WIRE HARNESS

(71) Applicant: Yazaki Corporation, Tokyo (JP)

(72) Inventors: Kazuomi KIYOSUE, Shizuoka (JP); Akinori NAKASHIMA, Shizuoka (JP); Takeshi ISHIKAWA, Shizuoka (JP); Daiki ITO, Shizuoka (JP); Dai ARAI, Shizuoka (JP)

(73) Assignee: Yazaki Corporation, Tokyo (JP)

(21) Appl. No.: 19/018,161

(22) Filed: Jan. 13, 2025

(30) Foreign Application Priority Data
Feb. 15, 2024 (JP) 2024-020744

(51) Int. Cl. H01B 7/40; B60R 16/02; H01B 7/00

(52) U.S. Cl. CPC H01B 7/40; H01B 7/0045; B60R 16/0207

(57) ABSTRACT

A wire harness includes: a wiring member having conductivity; and a molded member provided integrally with the wiring member so as to cover the wiring member. The molded member includes: a main body portion covering an outer side of the wiring member; and an anchor portion that is formed in a plate shape so as to be elastically deformable in a plate thickness direction and is able to be inserted into and fixed to a fixing recess formed in a fixing target portion. With this configuration, the wire harness has an effect of achieving appropriate routing.

### CROSS-REFERENCE TO RELATED APPLICATION(S)

The present application claims priority to and incorporates by reference the entire contents of Japanese Patent Application No. 2024-020744 filed in Japan on Feb. 15, 2024.

### BACKGROUND OF THE INVENTION

### 1. Field of the Invention

The present invention relates to a wire harness.

### 2. Description of the Related Art

For example, Japanese Patent Application Laid-open No. 2019-160568 A discloses a wire harness for supplying power to various devices installed in a vehicle. The wire harness includes an electric wire and a molded body formed of a thermoplastic material and integrally provided with the electric wire so as to be exposed to an outer surface of the electric wire. The molded body has a fusion surface for fixing the electric wire to the surface of the sheet material by heat fusion.

In the conventional wire harness, for example, there is room for further improvement from the viewpoint of workability at the time of routing the wire harness to the vehicle.

### SUMMARY OF THE INVENTION

The present invention has been made in view of the above circumstances and aims to provide a wire harness capable of appropriately achieving routing.

In order to achieve the above mentioned object, a wire harness according to one aspect of the present invention includes a wiring member having conductivity; and a molded member provided integrally with the wiring member so as to cover the wiring member, wherein the molded member includes: a main body portion covering an outer side of the wiring member; and an anchor portion that is formed in a plate shape so as to be elastically deformable in a plate thickness direction and is able to be inserted into and fixed to a fixing recess formed in a fixing target portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic cross-sectional view illustrating a schematic configuration of a wire harness according to an embodiment;

FIG. 2 is a schematic side view illustrating a schematic configuration of a wire harness according to the embodiment;

FIG. 3 is a schematic cross-sectional view illustrating an example of a routing/fixing mode of a wire harness according to a modification;

FIG. 4 is a schematic cross-sectional view illustrating an example of a routing/fixing mode of a wire harness according to a modification;

FIG. 5 is a schematic cross-sectional view illustrating a schematic configuration of a wire harness according to a modification; and

FIG. 6 is a schematic cross-sectional view illustrating a schematic configuration of a wire harness according to a modification.

### DETAILED DESCRIPTION OF THE PREFERRED EMBODIMENTS

Embodiments according to the present invention will be described below in detail with reference to the drawings. Note that the present invention is not limited by the present embodiment. Moreover, components in the following embodiment include those easily interchangeable by those skilled in the art or substantially identical.

### Embodiment

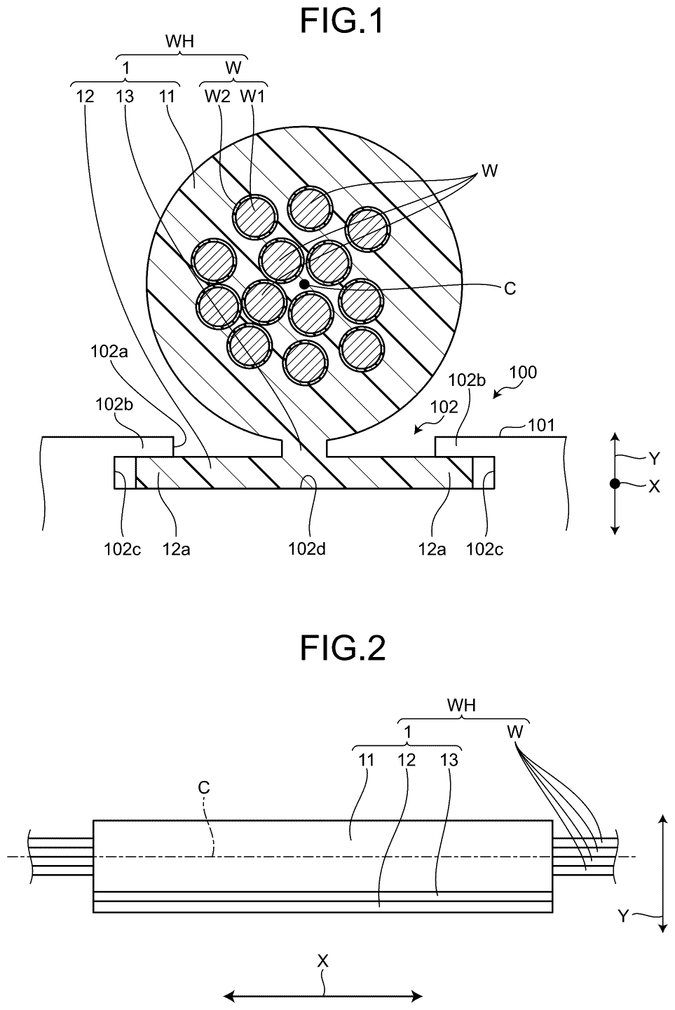

A wire harness WH according to the present embodiment illustrated in FIGS. 1 and 2 is to be routed in a vehicle or the like. The wire harness WH is formed as a component assembly by bundling a plurality of wiring members W used for power supply and signal communication to achieve electrical connection between devices mounted on a vehicle, with the plurality of wiring members W connected to each of the devices via connectors or the like. The wire harness WH of the present embodiment includes: a plurality of wiring members W having conductivity; and a molded member 1 integrally provided around the plurality of wiring members W so as to bundle the plurality of wiring members W.

The wiring member W is, for example, an insulated wire in which a core wire W1, which is a bundle of a plurality of conductive metal element wires, is covered with an insulating covering portion W2. The wiring member W may be an electrical wire bundle, being a bundle of a plurality of insulated wires. In addition, the wiring member W may be an insulating metal rod which is a conductive metal rod covered with an insulating covering portion. The molded member 1 is provided integrally with the wiring member W so as to cover the wiring member W, and is provided as an exterior member for the wiring member W. The wire harness WH may further include various other components such as a corrugated tube, a grommet, and an electrical connection box.

The molded member 1 according to the present embodiment includes an anchor portion 12 formed in a plate shape as a fixing portion to a fixing target portion 100, in addition to the portion covering the wiring member W, thereby achieving a configuration that improves workability at the time of performing routing to the vehicle. Hereinafter, each configuration of the molded member 1 will be described in detail with reference to the drawings.

Here, the fixing target portion 100 to which the anchor portion 12 is fixed is provided, for example, on a routing surface 101 on which the wire harness WH is routed in various structural members such as a body member of a vehicle. The fixing target portion 100 of the present embodiment includes a fixing recess 102 formed in a recessed shape in the routing surface 101, and the anchor portion 12 is inserted into and fixed to the fixing recess 102. Here, the fixing recess 102 is formed with a claw-shaped portion 102b at an edge of an opening 102a on the routing surface 101 side. At the edge of the opening 102a, the claw-shaped portion 102b is formed in a claw shape so as to protrude from a side wall 102c of the fixing recess 102 to the inner side of the opening 102a.

Specifically, as illustrated in FIGS. 1 and 2, the molded member 1 includes a main body portion 11, an anchor portion 12, and a connecting portion 13. The molded member 1 is formed of an insulating elastic resin material having low rigidity and high flexibility (for example, ethylene-propylene-diene rubber (EPDM)), such as rubber or thermoplastic elastomer. The molded member 1 has the elastic resin material integrally provided around the plurality of wiring members W so as to bundle the plurality of wiring members W by molding such as injection molding, whereby the individual portions such as the main body portion 11, the anchor portion 12, and the connecting portion 13 are directly integrally formed with the wiring members W. This makes it possible to give flexibility to the wire harness WH together with the molded member 1. Here, as an example, the molded member 1 has a configuration in which individual portions such as the main body portion 11, the anchor portion 12, and the connecting portion 13 are formed straight in an extending direction X of the wiring member W.

The main body portion 11 is a portion covering the outside of the wiring member W, and constitutes a main portion that functions as an exterior member of the wiring member W. The main body portion 11 is provided in the extending direction X in which the plurality of wiring members W extends, and holds the surroundings of the plurality of wiring members W so as to bundle the plurality of wiring members W. Typically, while covering and protecting the plurality of wiring members W, the main body portion 11 restricts a path through which the plurality of wiring members W is routed. The main body portion 11 collectively covers some sections of the plurality of wiring members W, so as to embed the some sections of the plurality of wiring members W.

As an example, as illustrated in FIG. 1, the main body portion 11 of the present embodiment is formed in a substantially columnar shape in which the direction along an axis C is aligned with the direction running in the extending direction X of the wiring member W. Here, the main body portion 11 is provided so as to cover the entire wiring members W in the circumferential direction. Inside the main body portion 11, the plurality of wiring members W is arranged around the axis C of the column forming the shape of the main body portion 11.

The insulating covering portion W2 constituting the wiring member W is typically an insulating covering member provided over substantially the entire length of the wiring member W in the extending direction X. On the other hand, the main body portion 11 is a protection member locally provided at a necessary portion of the wiring member W, such as a portion needing protection of the wiring member W and path restriction on the further outer side of the insulating covering portion W2 as the covering member.

The anchor portion 12 is a portion formed in a plate shape and fixed to the fixing target portion 100, and constitutes a sub-portion functioning as an exterior member of the wiring member W. The anchor portion 12 is formed in a plate shape so as to be elastically deformable in a plate thickness direction Y. The anchor portion 12 can be inserted into and fixed to the fixing recess 102 formed in the fixing target portion 100.

The anchor portion 12 of the present embodiment is formed in a substantially rectangular plate shape in which the plate thickness direction Y is aligned with a direction orthogonal to the extending direction X of the wiring member W, and is positioned to face the main body portion 11 with respect to the plate thickness direction Y. Here, the anchor portion 12 is connected to the main body portion 11 via the connecting portion 13. In addition, as an example, as illustrated in FIG. 2, the anchor portion 12 of the present embodiment is provided over substantially the entire length along the outer circumferential surface of the main body portion 11 with respect to the extending direction X of the wiring member W. The anchor portion 12 is inserted into and fixed to the fixing recess 102, thereby fixing and supporting the entire molded member 1 including the main body portion 11 to the fixing target portion 100.

The connecting portion 13 is a portion that connects the main body portion 11 and the anchor portion 12 to each other. The connecting portion 13 is interposed between the main body portion 11 and the anchor portion 12 in the plate thickness direction Y of the anchor portion 12, and functions as a portion connecting the main body portion 11 and the anchor portion 12 to each other in the plate thickness direction Y. Here, the connecting portion 13 is formed as a portion narrowed between the main body portion 11 and the anchor portion 12 so as not to hinder elastic deformation of the anchor portion 12 in the plate thickness direction Y in the molded member 1. As an example, similarly to the anchor portion 12, the connecting portion 13 of the present embodiment is provided over substantially the entire length along the outer circumferential surface of the main body portion 11 with respect to the extending direction X of the wiring member Was illustrated in FIG. 2.

As an example, the molded member 1 configured as described above is fixed to the fixing target portion 100 in the routing/fixing mode illustrated in FIG. 1. In this case, the molded member 1 allows the anchor portion 12 to be pushed into the fixing recess 102 so as to be bent with elastic deformation in the plate thickness direction Y, allowing the anchor portion 12 to be inserted into the fixing recess 102.

The molded member 1 in the routing/fixing mode illustrated in FIG. 1 is configured such that, in a state where the anchor portion 12 is inserted into the fixing recess 102, the elastically deformed anchor portion 12 returns to its original shape and is placed on a bottom wall 102d of the fixing recess 102. In this state, the molded member 1 causes a plate-shaped end portion 12a of the anchor portion 12 to be locked to the claw-shaped portion 102b formed at the edge of the opening 102a of the fixing recess 102. With this configuration, even when an external force acts in a direction in which the anchor portion 12 comes out of the fixing recess 102, the plate-shaped end portion 12a is caught and locked by the claw-shaped portion 102b, making it possible for the molded member 1 to restrict the anchor portion 12 from coming out of the fixing recess 102. As a result, the molded member 1 can maintain a state of being fixed to the fixing target portion 100 via the anchor portion 12.

In the wire harness WH described above, the main body portion 11 of the molded member 1, integrally provided so as to cover the wiring member W, can protect the wiring member W and restrict the path in which the wiring member W is routed. In this configuration of the wire harness WH, the anchor portion 12 of the molded member 1 is inserted into and fixed to the fixing recess 102 of the fixing target portion 100 with the anchor portion 12 being subjected to elastic deformation, making it possible to fix and support, via the anchor portion 12, the entire molded member 1 to the fixing target portion 100 such as the routing surface 101. As a result, as compared with a case where a fixing tool such as a band clamp or a clip is separately assembled to the wiring member W and fixed to the fixing target portion 100, for example, the wire harness WH can be appropriately routed at a predetermined position of the vehicle with suppressed number of work steps with appropriate workability ensured.

In addition, since the wire harness WH can be fixed to the fixing target portion 100 via the anchor portion 12 in a state where the main body portion 11 of the molded member 1 is exposed from the fixing recess 102 instead of being accommodated in the fixing recess 102, and this makes it possible, for example, to facilitate achievement of a structure in which another unit such as a branch portion is added to the main body portion 11.

Still further, by forming the molded member 1 by injection molding (forming by molding) instead of extrusion molding or the like, the wire harness WH can directly provide the molded member 1 having various shapes onto the wiring member W on a jig plate using a mold (die) in the manufacturing process, for example. This makes it possible to eliminate necessity to manually assemble a protective member such as a protector, for example, enabling automatic manufacturing of the wire harness WH by various manufacturing apparatuses. This leads to high manufacturing efficiency of the wire harness WH, making it possible to contribute to automation of the manufacturing process by performing injection molding (forming by molding) on the jig plate.

Here, the wire harness WH described above has the molded member 1 including the connecting portion 13, which connects the main body portion 11 and the anchor portion 12 to each other. With this configuration, since the connecting portion 13 is interposed between the main body portion 11 and the anchor portion 12, the wire harness WH can achieve a configuration in which the anchor portion 12 is unlikely to interfere with the main body portion 11 when the anchor portion 12 is elastically deformed in the plate thickness direction Y. As a result, the wire harness WH can be appropriately routed with appropriate workability ensured.

In addition, here, in the wire harness WH described above, the plate-shaped end portion 12a of the anchor portion 12 is locked to the claw-shaped portion 102b formed at the edge of the opening 102a of the fixing recess 102 in a state where the anchor portion 12 is inserted into the fixing recess 102. With this configuration of the wire harness WH, even when an external force acts on the molded member 1 in a direction in which the anchor portion 12 comes out of the fixing recess 102, the plate-shaped end portion 12a is caught and locked by the claw-shaped portion 102b, making it possible to restrict the anchor portion 12 from coming out of the fixing recess 102. As a result, the wire harness WH can maintain the state in which the molded member 1 is fixed to the fixing target portion 100 via the anchor portion 12, making it possible to maintain the state in which the wire harness WH is appropriately routed.

Note that the wire harness according to the above-described embodiment of the present invention are not limited to the above-described embodiment, and various modifications can be made within the scope described in the claims.

In the above description, the molded member 1 has been described assuming that individual portions including the main body portion 11, the anchor portion 12, and the connecting portion 13 are to be formed straight in the extending direction X of the wiring member W, but the shape of the molded member 1 is not limited thereto. The molded member 1 may have each portion, such as the main body portion 11, the anchor portion 12, and the connecting portion 13, formed in a bent or curved shape according to the routing path of the wiring member W.

Although the above has described an exemplary configuration in which the anchor portion 12 and the connecting portion 13 are provided over substantially the entire length of the main body portion 11 in the extending direction X of the wiring member W, but arrangement is not limited thereto. For example, the anchor portions 12 and the connecting portions 13 may be provided locally at necessary portions in the main body portion 11 and in plurality at intervals in the extending direction X.

Although the above has described an exemplary configuration in which the main body portion 11 is provided so as to cover the entire wiring members W in the circumferential direction, but the configuration of the main body portion 11 is not limited thereto. The main body portion 11 need not cover the entire wiring members W in the circumferential direction, and may be formed in a shape partially covering the wiring members W in the circumferential direction of the wiring members W, for example.

The above has described an exemplary configuration in which the anchor portion 12 is formed in a substantially rectangular plate shape in which the plate thickness direction Y is aligned with a direction orthogonal to the extending direction X of the wiring member W. However, the shape is not limited thereto, and the anchor portion may be formed in a plate shape having a shape other than a rectangle.

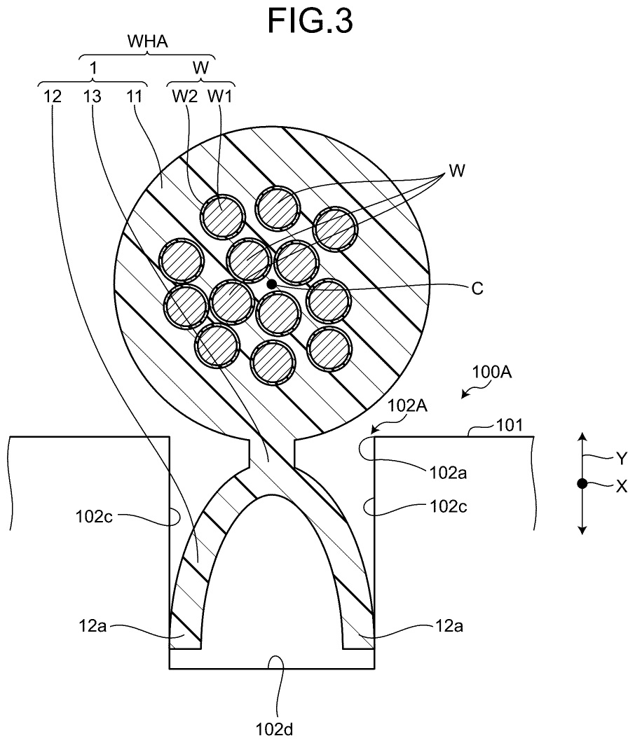

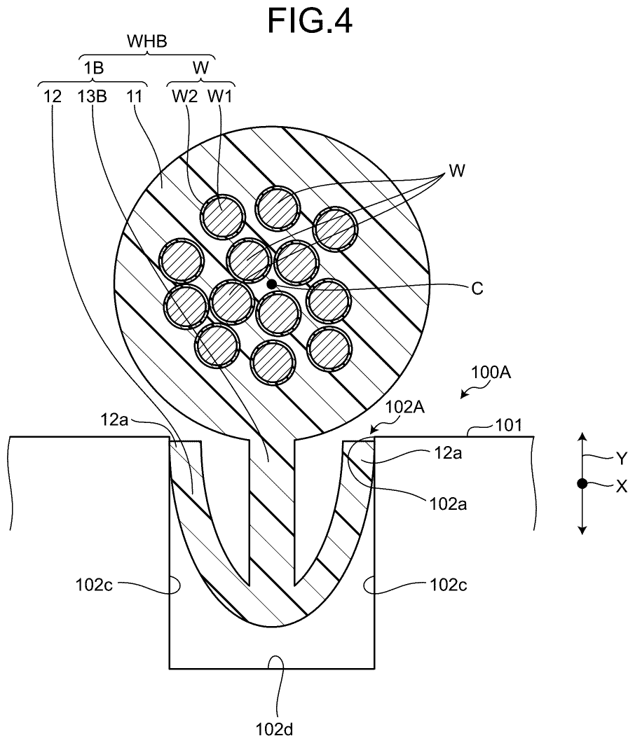

Although the above has described an exemplary configuration in which the molded member 1 is fixed to the fixing target portion 100 in the routing/fixing mode illustrated in FIG. 1, the routing/fixing mode is not limited thereto. Hereinafter, another example of the routing/fixing mode will be described with reference to FIGS. 3 and 4.

A wire harness WHA according to a modification illustrated in FIG. 3 is different from the wire harness WH described above in the shape of a fixing target portion 100A to be applied and the routing/fixing mode of the molded member 1. The fixing target portion 100A to which the wire harness WHA is applied is different from the fixing target portion 100 described above in that the depth of a fixing recess 102A is greater than the fixing recess 102 and that the claw-shaped portion 102b is not provided. Other configurations of the wire harness WHA and the fixing target portion 100A are substantially similar to those of the wire harness WH and the fixing target portion 100.

As an example, the molded member 1 of the wire harness WHA according to the present modification is fixed to the fixing target portion 100A in a routing/fixing mode illustrated in FIG. 3. In this case, the molded member 1 allows the anchor portion 12 to be pushed into the fixing recess 102A so as to be bent with elastic deformation such that individual plate-shaped end portions 12a face the bottom wall 102d side with the connecting portion with the connecting portion 13 as a base point, allowing the anchor portion 12 to be inserted into the fixing recess 102A.

The molded member 1 in the routing/fixing mode illustrated in FIG. 3 is configured such that, in a state where the anchor portion 12 is inserted into the fixing recess 102A in a state of being elastically deformed, each plate-shaped end portion 12a of the anchor portion 12 comes into contact with the side wall 102c, being an inner wall surface of the fixing recess 102A. In this state, each plate-shaped end portion 12a of the anchor portion 12 is pressed against each side wall 102c by elastic restoring force in the molded member 1. In other words, this state is a state in which the molded member 1 has the anchor portion 12 bent in a substantially V shape and press-fitted into the fixing recess 102A, forming a state of being positioned at a slight interval with respect to the bottom wall 102d of the fixing recess 102A. With this configuration, even when an external force acts in a direction in which the anchor portion 12 comes out of the fixing recess 102A, the molded member 1 can restrict the anchor portion 12 from coming out of the fixing recess 102A by frictional resistance generated between each plate-shaped end portion 12a and each side wall 102c. As a result, the molded member 1 can maintain a state of being fixed to the fixing target portion 100A via the anchor portion 12.

Even with the wire harness WHA described above, similarly to the wire harness WH described above, it is possible to appropriately route the wire harness WHA at a predetermined position of the vehicle.

In this case, in the wire harness WHA described above, the anchor portion 12 is inserted into the fixing recess 102A and comes into contact with the side wall 102c of the fixing recess 102A in a state where the anchor portion 12 is elastically deformed. With this configuration, even when an external force acts in a direction in which the anchor portion 12 comes out of the fixing recess 102A onto the molded member 1, the wire harness WHA can restrict the anchor portion 12 from coming out of the fixing recess 102A by frictional resistance generated between each plate-shaped end portion 12a and each side wall 102c. As a result, the wire harness WHA can maintain the state in which the molded member 1 is fixed to the fixing target portion 100A via the anchor portion 12, making it possible to maintain the state in which the wire harness WHA is appropriately routed.

A wire harness WHB according to a modification illustrated in FIG. 4 is different from the wire harness WHA described above in including a molded member 1B instead of the molded member 1 and in a routing/fixing mode of the molded member 1B. The molded member 1B is different from the above-described molded member 1 in that a connecting portion 13B is formed to be relatively longer than the above-described connecting portion 13. Other configurations of the wire harness WHB, the molded member 1B, and the connecting portion 13B are substantially similar to those of the wire harness WHA, the molded member 1, and the connecting portion 13, respectively.

As an example, the molded member 1B of the wire harness WHB according to the present modification is fixed to the fixing target portion 100A in a routing/fixing mode illustrated in FIG. 4. In this case, when the molded member 1B is pushed into the fixing recess 102, the anchor portion 12 takes a posture of being bent in a direction opposite to the case of the wire harness WHA described above. That is, the molded member 1B allows the anchor portion 12 to be pushed into the fixing recess 102A so as to be bent with elastic deformation such that individual plate-shaped end portions 12a face the opening 102a side with the connecting portion with the connecting portion 13B as a base point, allowing the anchor portion 12 to be inserted into the fixing recess 102A.

Similarly to FIG. 3, the molded member 1B in the routing/fixing mode illustrated in FIG. 4 is configured such that, in a state where the anchor portion 12 is inserted into the fixing recess 102A in a state of being elastically deformed, each plate-shaped end portion 12a of the anchor portion 12 comes into contact with the side wall 102c that is an inner wall surface of the fixing recess 102A. In this state, each plate-shaped end portion 12a of the anchor portion 12 is pressed against each side wall 102c by elastic restoring force in the molded member 1B. In other words, this state is a state in which the molded member 1B has the anchor portion 12 bent in a substantially V shape and press-fitted into the fixing recess 102A, forming a state of being positioned at a slight interval with respect to the bottom wall 102d of the fixing recess 102A. With this configuration, even when an external force acts in a direction in which the anchor portion 12 comes out of the fixing recess 102A, the molded member 1B can restrict the anchor portion 12 from coming out of the fixing recess 102A by frictional resistance generated between each plate-shaped end portion 12a and each side wall 102c. Also in this case, each of the folded plate-shaped end portions 12a of the molded member 1B faces the opening 102a side, and therefore, when the anchor portion 12 is about to move toward the opening 102a side in the direction in which the anchor portion 12 comes out of the fixing recess 102A, the folded plate-shaped end portion 12a itself resists the expanding movement to be returned in accordance with the pull-out operation, making it possible to further enhance prevention of the anchor portion 12 from coming out of the fixing recess 102A. As a result, the molded member 1B can maintain a state of being fixed to the fixing target portion 100A via the anchor portion 12.

Even with the wire harness WHB described above, similarly to the wire harnesses WH and WHA described above, it is also possible to appropriately route the wire harness WHB at a predetermined position of the vehicle. In this case, similarly to the wire harness WHA described above, the wire harness WHB can maintain the state in which the molded member 1B is fixed to the fixing target portion 100A via the anchor portion 12, making it possible to maintain the state in which the wire harness WHB is appropriately routed.

The above description is an example in which the molded members 1 and 1B include the connecting portions 13 and 13B, respectively, however, the configuration is not limited thereto, and there is no need to include the connecting portions 13 or 13B.

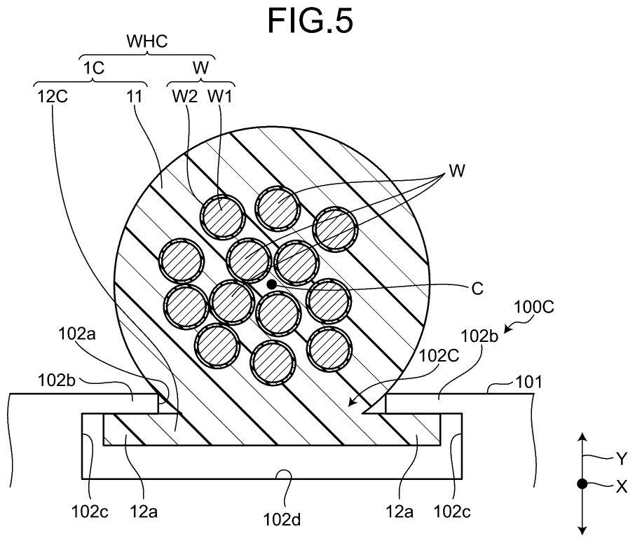

The wire harness WHC according to the modification illustrated in FIG. 5 is different from the wire harness WH described above in including a molded member 1C having no connecting portions 13 or 13B and the like instead of the molded member 1, the shape of a fixing target portion 100C to be applied, and the routing/fixing mode of the molded member 1C. The fixing target portion 100C to which the wire harness WHC is applied is different from the fixing target portion 100 described above in that the depth of a fixing recess 102C is greater than the fixing recess 102 described above. Here, the depth of the fixing recess 102C is less than that of the fixing recess 102A described above. Other configurations of the wire harness WHC and the fixing target portion 100C are substantially similar to those of the wire harness WH and the fixing target portion 100.

The molded member 1C of the present modification is different from the above-described molded member 1 in not including the connecting portion 13 and including an anchor portion 12C instead of the anchor portion 12. That is, the anchor portion 12C of the present modification is directly connected to the outer circumferential surface of the main body portion 11 without interposing the connecting portions 13, 13B, or the like. The anchor portion 12C of the present modification is formed to protrude from the main body portion 11 in a direction orthogonal to the extending direction X and the plate thickness direction Y. Here, the anchor portion 12C is formed to protrude in a plate shape from the outer circumferential surface of the main body portion 11 in such a positional relationship as to be in contact with the outer circumferential surface of the main body portion 11. The other configurations of the molded member 1C and the anchor portion 12C are substantially similar to those of the molded member 1 and the anchor portion 12.

As an example, the molded member 1C of the wire harness WHC according to the present modification is fixed to the fixing target portion 100C in a routing/fixing mode illustrated in FIG. 5. In this case, similarly to the above-described wire harness WH, the molded member 1C allows the anchor portion 12C to be pushed into the fixing recess 102C so as to be bent with elastic deformation in the plate thickness direction Y, allowing the anchor portion 12C to be inserted into the fixing recess 102C.

The molded member 1C in the routing/fixing mode illustrated in FIG. 5 is configured such that, in a state where the anchor portion 12C is inserted into the fixing recess 102C, the elastically deformed anchor portion 12C returns to its original shape. In this state, the plate-shaped end portion 12a of the anchor portion 12C is locked to the claw-shaped portion 102b formed at the edge of the opening 102a of the fixing recess 102C, and the molded member 1C is held such that the claw-shaped portion 102b is sandwiched between the plate-shaped end portion 12a and the main body portion 11. In other words, in this state, the molded member 1C is in a state of being fixed in position so as to sandwich the claw-shaped portion 102b between the plate-shaped end portion 12a and the main body portion 11, forming a state of being positioned at a slight interval with respect to the bottom wall 102d of the fixing recess 102C. With this configuration, even when an external force acts in a direction in which the anchor portion 12C comes out of the fixing recess 102C, the plate-shaped end portion 12a is caught and locked by the claw-shaped portion 102b, making it possible for the molded member 1C to restrict the anchor portion 12C from coming out of the fixing recess 102C. As a result, the molded member 1C can maintain a state of being fixed to the fixing target portion 100C via the anchor portion 12C.

Even with the wire harness WHC described above, similarly to the wire harnesses WH, WHA, and WHB described above, it is also possible to appropriately route the wire harness WHC at a predetermined position of the vehicle.

In this case, the wire harness WHC described above is formed with the anchor portion 12C protruding from the main body portion 11. With this configuration, the wire harness WHC can fix the position of the molded member 1C such that the claw-shaped portion 102b of the fixing recess 102C is sandwiched between the plate-shaped end portion 12a of the anchor portion 12C and the main body portion 11, for example, making it possible to maintain the state in which the wire harness WHC is appropriately routed.

Although the above description is an example in which the main body portion 11 of each of the molded members 1, 1B, and 1C is formed in a substantially columnar shape having the direction along the axis C being aligned with the direction in the extending direction X of the wiring member W, the configuration is not limited thereto. The main body portion 11 may be formed in, for example, a polygonal columnar shape, or may be formed in an irregular shape so as not to interfere with an obstacle or the like around the main body portion 11 in accordance with the shape of the obstacle or the like.

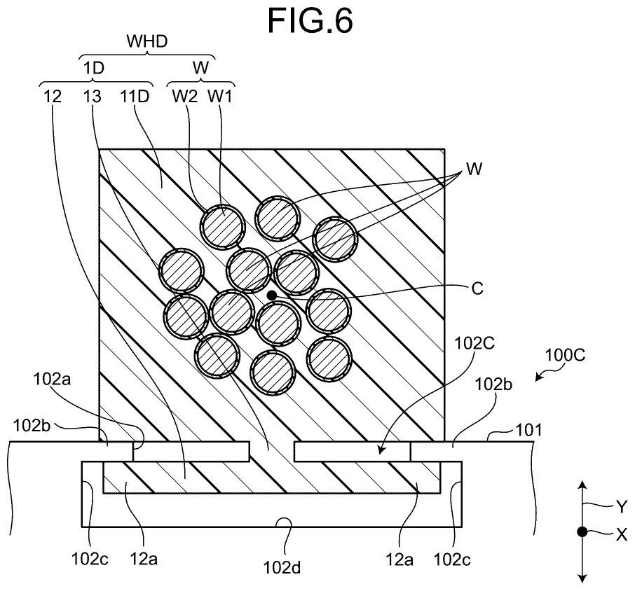

A wire harness WHD according to a modification illustrated in FIG. 6 is different from the wire harness WH described above in including a molded member 1D instead of the molded member 1, the shape of the fixing target portion 100C to be applied, and the routing/fixing mode of the molded member 1D. Other configurations of the wire harness WHD are substantially similar to those of the wire harness WH. The fixing target portion 100C to which the wire harness WHD is applied has a configuration similar to the configuration of the fixing target portion 100C to which the wire harness WHC is applied.

The molded member 1D of the present modification is different from the above-described molded member 1 in including a main body portion 11D instead of the main body portion 11. The main body portion 11D of the present modification is different from the main body portion 11 in that the main body portion 11D is formed in a substantially quadrangular prism shape having the direction along the axis C being aligned with the direction in the extending direction X of the wiring member W. Here, the main body portion 11D is provided so as to cover the entire wiring members W in the circumferential direction. Inside the main body portion 11D, the plurality of wiring members W is arranged around the axis C of the quadrangular prism being the shape of the main body portion 11D. Other configurations of the molded member 1D and the main body portion 11D are substantially similar to those of the molded member 1 and the main body portion 11.

As an example, the molded member 1D of the wire harness WHD according to the present modification is fixed to the fixing target portion 100C in a routing/fixing mode illustrated in FIG. 6. In this case, similarly to the above-described wire harness WH, the molded member 1D allows the anchor portion 12 to be pushed into the fixing recess 102C so as to be bent with elastic deformation in the plate thickness direction Y, allowing the anchor portion 12 to be inserted into the fixing recess 102C.

The molded member 1D in the routing/fixing mode illustrated in FIG. 6 is configured such that, in a state where the anchor portion 12 is inserted into the fixing recess 102C, the elastically deformed anchor portion 12 returns to its original shape. In this state, the plate-shaped end portion 12a of the anchor portion 12 is locked to the claw-shaped portion 102b formed at the edge of the opening 102a of the fixing recess 102C, and the molded member 1D is held such that the claw-shaped portion 102b is sandwiched between the plate-shaped end portion 12a and the outer surface of the main body portion 11D facing the anchor portion 12. In other words, in this state, the molded member 1D is in a state of being fixed in position so as to sandwich the claw-shaped portion 102b between the plate-shaped end portion 12a and the outer surface of the main body portion 11D facing the anchor portion 12, forming a state of being positioned at a slight interval with respect to the bottom wall 102d of the fixing recess 102C. With this configuration, even when an external force acts in a direction in which the anchor portion 12 comes out of the fixing recess 102C, the plate-shaped end portion 12a is caught and locked by the claw-shaped portion 102b, making it possible for the molded member 1D to restrict the anchor portion 12 from coming out of the fixing recess 102C. As a result, the molded member 1D can maintain a state of being fixed to the fixing target portion 100C via the anchor portion 12.

Even with the wire harness WHD described above, similarly to the wire harnesses WH, WHA, WHB, and WHC described above, it is also possible to appropriately route the wire harness WHC at a predetermined position of the vehicle.

In this case, the wire harness WHD described above can fix the position of the molded member 1D such that the claw-shaped portion 102b of the fixing recess 102C is sandwiched between the plate-shaped end portion 12a of the anchor portion 12 and the outer surface of the main body portion 11D facing the anchor portion 12, for example, making it possible to maintain the state in which the wire harness WHD is appropriately routed.

The wire harness according to the present embodiment may be configured by appropriately combining the components of the above-described embodiment and modifications.

The wire harness according to the present embodiment has an effect of achieving appropriate routing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a wiring member having conductivity; and
a molded member provided integrally with the wiring member so as to cover the wiring member, wherein
the molded member includes:
a main body portion covering an outer side of the wiring member; and
an anchor portion that is formed in a plate shape so as to be elastically deformable in a plate thickness direction and is able to be inserted into and fixed to a fixing recess formed in a fixing target portion.

2. The wire harness according to claim 1, wherein
the molded member includes a connecting portion connecting the main body portion and the anchor portion to each other.

3. The wire harness according to claim 1, wherein
the anchor portion is formed so as to protrude from the main body portion.

4. The wire harness according to claim 1, wherein
the anchor portion has a plate-shaped end portion that is locked to a claw-shaped portion formed at an edge of an opening of the fixing recess in a state where the anchor portion is inserted into the fixing recess.

5. The wire harness according to claim 2, wherein
the anchor portion has a plate-shaped end portion that is locked to a claw-shaped portion formed at an edge of an opening of the fixing recess in a state where the anchor portion is inserted into the fixing recess.

6. The wire harness according to claim 3, wherein
the anchor portion has a plate-shaped end portion that is locked to a claw-shaped portion formed at an edge of an opening of the fixing recess in a state where the anchor portion is inserted into the fixing recess.

7. The wire harness according to claim 1, wherein
the anchor portion comes into contact with an inner wall surface of the fixing recess in a state where the anchor portion is inserted into the fixing recess to be in an elastically deformed state.

8. The wire harness according to claim 2, wherein
the anchor portion comes into contact with an inner wall surface of the fixing recess in a state where the anchor portion is inserted into the fixing recess to be in an elastically deformed state.

9. The wire harness according to claim 3, wherein
the anchor portion comes into contact with an inner wall surface of the fixing recess in a state where the anchor portion is inserted into the fixing recess to be in an elastically deformed state.
